(19) United States
(12) Patent Application Publication
(10) Pub. No.: US 2006/0169154 A1
(43) Pub. Date: Aug. 3, 2006

(54) Article of manufacture for a surgeon to use to mark the anatomical site of an upcoming surgery

(76) Inventor: Owen A. Nelson, Uniontown, PA (US)

Correspondence Address: Owen A. Nelson, 164 Regency Drive, Uniontown, PA, 15401, US

(21) Appl. No.: 11/047,237

(22) Filed: Jan. 31, 2005

(51) Int. Cl. B41N 1/24

(52) U.S. Cl. 101/114

(57) ABSTRACT

In order to avoid wrong site or wrong side surgery, it is customary and in some cases, mandated by law or policy, that a surgeon mark the anatomical site to be operated upon while the patient is awake and capable of concurring with the surgeon that the appropriate site has been identified. This article of manufacture provides a mechanism for performing this task easily and safely, by making a mark on the skin which will survive the surgical preparation, providing the surgeon with a visual confirmation of correct site surgery at the time of skin incision.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of surgery and more specifically to an article of manufacture for a surgeon to use to mark the anatomical site of an upcoming surgery.

Wrong site surgery is considered to be one of the most preventable surgical complications which can be encountered. If it is assumed that the surgeon has correctly identified the patient, surgery, and site with no method of confirmation, then any error on the part of the surgeon can result in a wrong site surgery. Medical records in the operating suite as well as verbal communications between the patient and other members of the operative team (e.g. nurse, anesthesiologist) may add to the accuracy of site selection also. However, no method of preventing wrong site surgery is as effective as the practice of the surgeon marking the site to be operated on while the patient is still awake and able to concur that the site has been correctly identified. In the case of a minor, or mentally incompetent patient, the marking is generally done in the presence of an appropriate guardian.

The common practice for marking the surgical site is for the surgeon to use a pen of some variety to make a mark, or initials on the appropriate site as outlined. In common practice, the ink used may or may not be capable of surviving the surgical preparation, and the pen used may or may not have been used on a previous patient.

In the event the ink used does not survive the surgical preparation (eg if the ink is washed away when the site is scrubbed), the surgeon does not have immedite visual verification of correct site surgery at the time of skin incision. Furthermore, if the same pen is used to mark sequential patients, it is possible to carry bacterial contamination from one patient to the next. Finally, using a pen does not have the same ‘flair’ as providing the mark with a prepared ‘tatooing’ template. Using the described article allows the surgeon to mark the operative site with some fanfare announcing to the patient with an air of authority that the surgery will be performed on the correct site.

### BRIEF SUMMARY OF THE INVENTION

The primary object of the invention is to provide positive identification of surgical site in pre-operative suite.

Another object of the invention is to mark surgical site with an ink which will not be removed by surgical preparation.

Another object of the invention is to provide a marker which can be used once and disposed of (infection control).

A further object of the invention is to provide the site identification mark in a manner that puts the patient at ease.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed an article of manufacture for a surgeon to use to mark the anatomical site of a proposed surgery comprising: a backing wafer of water impervious fabric, paper, or plastic material (11), a blotter wafer of fabric, paper, or plastic material saturated with a non-toxic indelible ink (12), a masking wafer of water impervious fabric, paper, or plastic material (13), and a capping wafer of water impervious fabric, paper, or plastic material (14). Said article is to be assembled in the manner described so that the surgeon can peel away the capping wafer, exposing the masked blotter, and by placing the exposed blotter against the patient's skin, leave a mark of indelible ink which will provide the surgeon with a visual verification of correct site surgery at the time of skin incision.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention. Whereas the invention is illustrated as circular components, it is understood that in use, the invention may assume any shape or size.

FIG. 1 is an exploded view of the invention.

FIG. 2 is a partially exploded view of the invention showing the order of stacking of the component parts.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

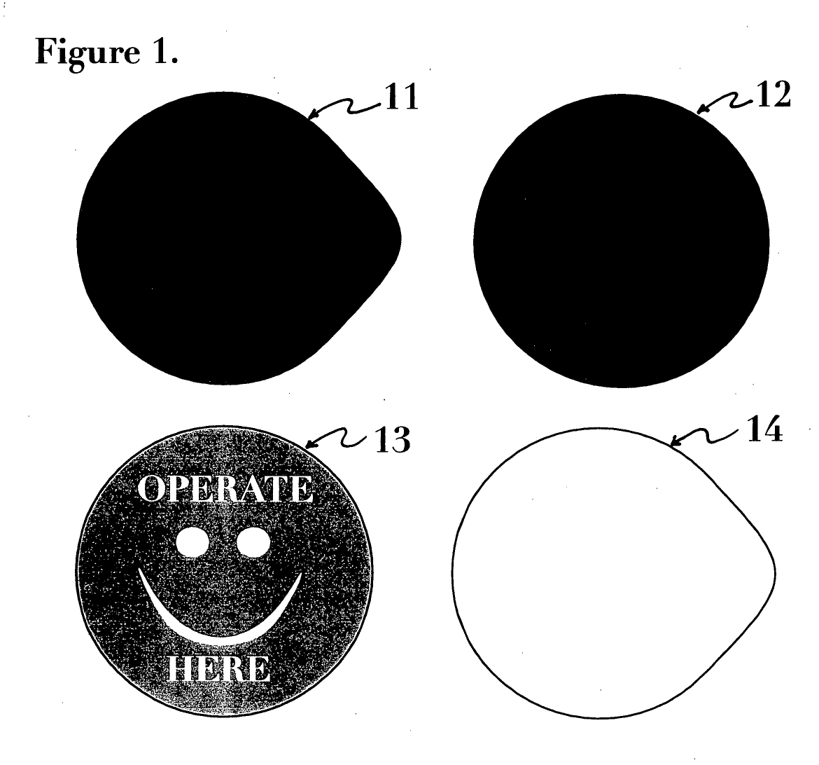

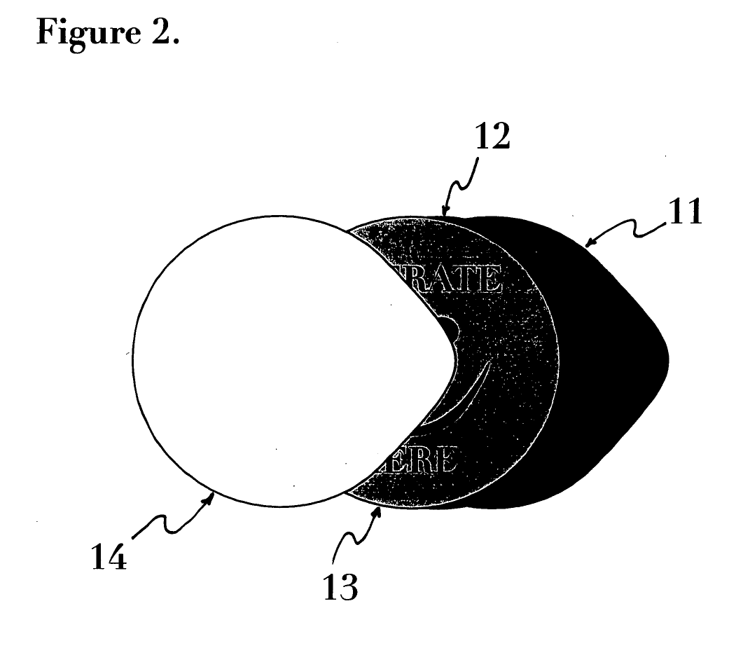

To accomplish the important function of the invention, there is shown in FIG. 1 the component parts of the invention, including a backing wafer of water impervious fabric, paper, or plastic material (11), a blotter wafer of fabric, paper, or plastic material saturated with a non-toxic indelible ink (12), a masking wafer of water impervious fabric, paper, or plastic material (13), and a capping wafer of water impervious fabric, paper, or plastic material (14). In FIG. 2 the component parts are again shown in a partially exploded representation to demonstrate the correct stacking order to accomplish the function of the invention. In the actual application, the four component parts would be assembled directly on one another but in the order demonstrated in FIG. 2.

In the preferred construction of the invention, the backing (11), the ink saturated blotter (12), and the masking (13) wafers will be stacked in the order shown in FIG. 2 and bonded together using any suitable mechanical or chemical bonding technique. The edges of the wafers will be sealed again by appropriate technique so the ink in the blotter will not dry out. The exposed surface of the masking wafer (13) will be coated with a light adhesive which will hold the capping wafer (14) in place and complete the water proof envelope for the ink blotter. To be used, the capping wafer (14) will be peeled away by the surgeon, the masking wafer (13) will be applied directly to the skin at the operative site and the adhesive will hold the invention in place. With light pressure applied, the ink will be transferred to the skin leaving an ink ‘tatoo’ matching the design on the masking wafer (13). The entire invention can then be peeled off the marked site and disposed of in a manner consistant with the infection control policies of the institution where being used. To facilitate handling, the backing (11) and capping (14) wafers would each have a tab extended from one margin and these tabs would not be bonded together.

In the illustrated embodiment, the masking wafer (13) contains the phrase ‘OPERATE HERE’ and a ‘smiley face’ logo. However, one of the features of the invention is that the masking wafer (13) may contain any word, phrase, or logo which is desired by the user of the invention. For example, when the invention is being used in a particular hospital, that hospital's logo or trademark may be included in the mask. Or in a pediatric setting, the logo may be a shape or object that is familiar to a small child, thereby helping to put the child at ease for the upcoming surgery.

Another feature of the invention is that the blotter wafer may contain ink of any color as long as it is indelible and compatible with the circumstances of the upcoming surgery. Furthermore, the blotter wafer could be constructed as a mosaic which, when used with the appropriate mask could provide additional and more complex detail when the invention is applied to the patient's skin.

The application of the invention as described therefore provides a reproducible and easily recognizable mark to clearly identify the anatomical site of the upcoming surgery. It is compatible with infection control policies. And when applied properly in the correct setting will provide the patient with the peace of mind knowing that the correct site will be operated upon. Furthermore, if the institution using the invention chooses to use their own identity as a logo, it announces to the patient that patient safety and correct site surgery is an institutional policy.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. An article of manufacture for a surgeon to use to mark the anatomical site of a proposed surgery comprising:
A backing wafer of water impervious fabric, paper, or plastic material (11);
A blotter wafer of fabric, paper, or plastic material saturated with a non-toxic indelible ink (12);
A masking wafer of water impervious fabric, paper, or plastic material from which a word or phrase and/or logo have been cut away (13); and
A capping wafer of water impervious fabric, paper, or plastic material (14).

2. The invention of claim 1 wherein the four said wafers are assembled into a single-use disposable composite article as demonstrated in FIG. 2;
The backing (11), the blotter (12), and the mask (13) are permanently bonded together; and the cap is designed to peel away to expose the underlying masked blotter.

3. The invention of claim 1 wherein the surgeon can peel the capping wafer (14) away, exposing the masked blotter which, when applied to the skin of the patient, will leave an indelible mark in the shape of the mask.
